(19) United States
(12) Patent Application Publication
(10) Pub. No.: US 2008/0151120 A1
(43) Pub. Date: Jun. 26, 2008

(54) IMAGE REPRODUCING APPARATUS AND METHOD OF IMPROVING IMAGE QUALITY

(75) Inventor: Hak-jae KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/849,386

(22) Filed: Sep. 4, 2007

(30) Foreign Application Priority Data
Dec. 26, 2006 (KR) 10-2006-134102

(51) Int. Cl. H04N 5/00

(52) U.S. Cl. 348/607

(57) ABSTRACT

An image reproducing apparatus and a method of improving an image quality are provided. The image reproducing apparatus includes a first filter unit which filters an input image signal, a second filter unit which amplifies the input image signal filtered through the first filter unit, and a control unit which measures a frequency level of the input image signal and controls the first filter unit to filter the input image signal on the basis of the measured frequency level. The amount of noise included in the input image signal and the frequency level of the input image signal are measured and the input image signal is selectively filtered based on the measured noise and frequency level, so that the noise included in the input image signal can be reduced with the image quality improved.

### CROSS-REFERENCE TO RELATED APPLICATIONS

This application claims priority under 35 U.S.C. § 119 from Korean Patent Application No. 10-2006-0134102, filed on Dec. 26, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to improving an image quality, and more particularly, to improving an image quality, which can reduce noise included in an input image signal by selectively filtering the input image signal in accordance with an amount of noise included in the input image signal.

2. Description of the Related Art

An image reproducing apparatus is an apparatus that displays an image on a display screen by projecting an image signal composed of RGB color signals onto the screen. A television receiver (TV), a camcorder, a digital camera, a set-top box (STB), a PnP, and so forth, may be the representative image reproducing apparatuses.

FIG. 1 is a block diagram illustrating the construction of a conventional image reproducing apparatus.

Referring to FIG. 1, the conventional image reproducing apparatus 100 comprises a manipulation unit 110, a peaking gain providing unit 120, and an horizontal/vertical (H/V) peaking filter 120.

The manipulation unit 110 is composed of buttons, a touch panel, and so forth, and receives necessary information from a user. The manipulation unit 110 receives a horizontal gain control command and a vertical gain control command for controlling amounts of horizontal gain and vertical gain of an input image signal, from the user.

If the horizontal gain control command and the vertical gain control command are received through the manipulation unit 110, the peaking gain providing unit 120 outputs a horizontal gain value and a vertical gain value, which correspond to the horizontal gain control command and the vertical gain control command, respectively, to the H/V peaking filter 130. Here, the horizontal gain value is a value for adjusting the horizontal frequency of an input image signal, and the vertical gain value is a value for adjusting the vertical frequency of the input image signal.

The H/V peaking filter 130 generates an output image signal by multiplying the input image signal by the horizontal gain value and the vertical gain value input from the peaking gain providing unit 120. The generated output image signal is processed in a specified method and then output to a display screen.

According to the conventional image reproducing apparatus as described above, however, since the output image signal is generated by multiplying the input image signal by the horizontal gain value and the vertical gain value input by the user, noise, which may be included in large quantities in the input image signal, is amplified during the above-described process and this causes the image quality to deteriorate.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image reproducing apparatus and a method of improving an image quality, which can reduce noise included in an input image signal by measuring the noise included in the input image signal and the frequency level of the input image signal and selectively filtering the input image signal on the basis of the measured noise and frequency level.

The foregoing and other objects and advantages are substantially realized by providing an image reproducing apparatus, according to exemplary embodiments of the present invention, which comprises a first filter unit which filters an input image signal in different ways; a second filter unit which amplifies the input image signal filtered through the first filter unit; and a control unit which measures a frequency level of the input image signal and controls the first filter unit to filter the input image signal in the different ways on the basis of the measured frequency level.

The image reproducing apparatus according to exemplary embodiments of the present invention may further comprise a noise measuring unit which measures an amount of noise included in the input image signal. In this case, the control unit may control the first filter unit to filter the input image signal in the different ways on the basis of the measured frequency level of the input image signal if the amount of noise of the input image signal is within a predetermined range.

The first filter unit may comprise a low pass filter, a band pass filter, and a high pass filter. In this case, the control unit may output the input image signal to the low pass filter if it is judged that the frequency of the input image signal is lower than a first reference frequency, output the input image signal to the band pass filter if it is judged that the frequency of the input image signal is lower than a second reference frequency, and output the input image signal to the high pass filter if it is judged that the frequency of the input image signal is higher than the second reference frequency.

The low pass filter may pass a frequency component that is lower than the first reference frequency among the frequencies of the input image signal; the band pass filter may pass a frequency component that is higher than the first reference frequency, but is lower than the second reference frequency among the frequencies of the input image signal; and the high pass filter may pass a frequency component that is higher than the second reference frequency among the frequencies of the input image signal.

The control unit may output the input image signal to the second filter unit if it is judged that the amount of noise in the input image signal is within the predetermined range.

The image reproducing apparatus according to exemplary embodiments of the present invention may further comprise a noise measuring unit which measures an amount of noise included in the input image signal. In this case, the control unit may provide a predetermined first peaking gain value to the second filter unit if it is judged that the amount of noise in the input image signal is within a predetermined first reference noise range, provide a predetermined second peaking gain value to the second filter unit if it is judged that the amount of noise is within a predetermined second reference noise range, and provide a predetermined third peaking gain value to the second filter unit if it is judged that the amount of noise is within a predetermined third reference noise range; and the second filter unit may amplify the input image signal by multiplying the input image signal by any one of the first to third peaking gain values input from the control unit.

According to another aspect of exemplary embodiments of the present invention, there is provided a method of improving an image quality, which comprises a first step of filtering an input image signal in different ways; a second step of amplifying the filtered input image signal; and a third step of measuring a frequency level of the input image signal and filtering the input image signal in the different ways on the basis of the measured frequency level.

The method according to exemplary embodiments of the present invention may further comprise measuring an amount of noise included in the input image signal. In this case, the third step may control the first step to filter the input image signal in the different ways on the basis of the measured frequency level of the input image signal if the amount of noise of the input image signal is within a predetermined range.

The first step may comprise a low pass filtering step, a band pass filtering step, and a high pass filtering step. In this case, the third step may output the input image signal to the low pass filtering step if it is judged that the frequency of the input image signal is lower than a first reference frequency, output the input image signal to the band pass filtering step if it is judged that the frequency of the input image signal is lower than a second reference frequency, and output the input image signal to the high pass filtering step if it is judged that the frequency of the input image signal is higher than the second reference frequency.

The low pass filtering step may pass a frequency component that is lower than the first reference frequency among the frequencies of the input image signal; the band pass filtering step may pass a frequency component that is higher than the first reference frequency, but is lower than the second reference frequency among the frequencies of the input image signal; and the high pass filtering step may pass a frequency component that is higher than the second reference frequency among the frequencies of the input image signal.

The third step may output the input image signal to the second step if it is judged that the amount of noise in the input image signal is within the predetermined range.

The method according to exemplary embodiments of the present invention may further comprise measuring an amount of noise included in the input image signal. In this case, the third step may provide a predetermined first peaking gain value to the second step if it is judged that the amount of noise in the input image signal is within a predetermined first reference noise range, provide a predetermined second peaking gain value to the second step if it is judged that the amount of noise is within a predetermined second reference noise range, and provide a predetermined third peaking gain value to the second step if it is judged that the amount of noise is within a predetermined third reference noise range; and the second step may amplify the input image signal by multiplying the input image signal by any one of the first to third peaking gain values input at the third step.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating the construction of a conventional image reproducing apparatus;

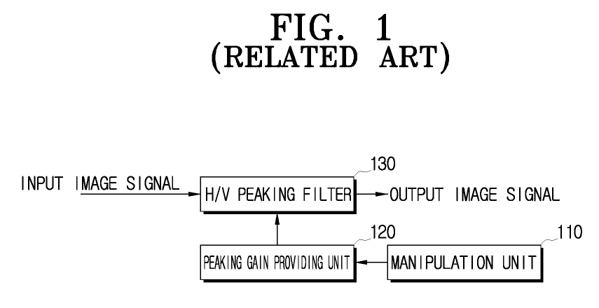

FIG. 2 is a block diagram illustrating the construction of an image reproducing apparatus according to an exemplary embodiment of the present invention; and

FIG. 3 is a flowchart illustrating a method of operating the image reproducing apparatus according to an exemplary embodiment of the present invention.

Throughout the drawings, like reference numerals will be understood to refer to like parts, components and structures.

### DETAILED DESCRIPTION OF EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

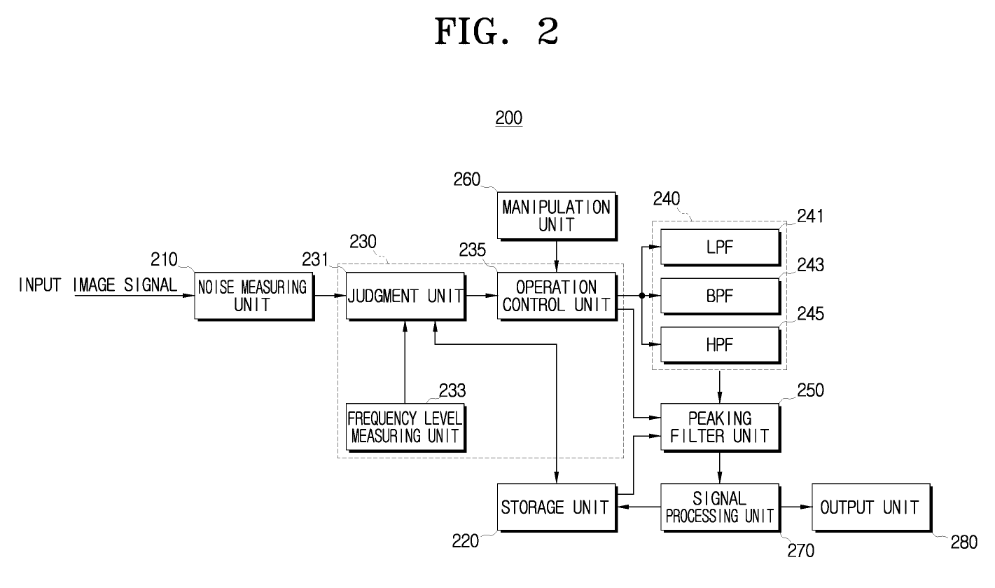

FIG. 2 is a block diagram illustrating the construction of an image reproducing apparatus according to an exemplary embodiment of the present invention.

Referring to FIG. 2, the image reproducing apparatus 200 according to an exemplary embodiment of the present invention comprises a noise measuring unit 210, a storage unit 220, a control unit 230, a filter unit 240, a peaking filter unit 250, a manipulation unit 260, a signal processing unit 270, and an output unit 280.

The noise measuring unit 210 measures an amount of noise included in an input image signal. That is, the noise measuring unit 210 measures the amount of noise included in a black period of a vertical sync (v-sync) signal of the input image signal. Here, the blank period is a specified front/back period where no image signal exists in a cycle.

Specifically, the noise measuring unit 210 performs a sampling of frequencies existing in the blank period, and obtains an average of the sampled frequencies to measure the amount of noise.

The storage unit 220 stores therein various kinds of programs required for the operation of the image reproducing apparatus 200, first to third reference noise ranges, first and second reference frequencies, and first to third peaking gain values. In this case, the first to third reference noise ranges, the first and second reference frequencies, and the first to third peaking gain values are predetermined, and the first and second peaking gain values can be input by a user through the manipulation unit 260.

The control unit 230, with reference to the storage unit 220, measures the frequency level of the input image signal on the basis of the amount of noise measured by the noise measuring unit 210, and operates to remove the noise included in the input image signal on the basis of the measured frequency level. The control unit 230 comprises a judgment unit 231, a frequency level measuring unit 233, and an operation control unit 235.

The judgment unit 231, with reference to the storage unit 220, compares the measured amount of noise in the input image signal with the first to third reference noise ranges, and judges whether the amount of noise in the input image signal is within any one of the first to third reference noise ranges.

If it is judged that the amount of noise in the input image signal is within the first or second reference noise range, the judgment unit 231, with reference to the storage unit 220, compares the frequency level of the input image signal measured by the frequency level measuring unit 233 with the predetermined first and second reference frequency levels, and outputs the result of comparison to the operation control unit 235 to be described later.

If the judgment unit 231 judges that the amount of noise in the input image signal is within the first or second reference noise range, the frequency level measuring unit 233 measures the frequency level of the input image signal.

Specifically, the frequency level measuring unit 233 measures the frequency level of the input image signal by obtaining an average of the levels of frequencies included in the input image signal, and outputs the measured frequency level of the input image signal to the judgment unit 231.

If the judgment unit 231 judges that the amount of noise in the input image signal is within the third reference noise range, the operation control unit 235, with reference to the storage unit 220, provides the third peaking gain value as an input of the peaking filter unit 250 to be described later. At this time, if it is judged that the amount of noise in the input image signal is within the third reference noise range, the operation control unit 235 directly provides the input image signal to the peaking filter unit 250 without filtering.

Specifically, if it is judged that the amount of noise in the input image signal is within the third reference noise range, i.e., if it is judged that a lot of noise is included in the input image signal, the operation control unit 235 does not provides the input image signal to the filter unit 240, but directly provides the input image signal to the peaking filter unit 250. In this case, the operation control unit 233 also provides the third peaking gain value that is used to amplify the input image signal as an input of the peaking filter unit 250. Here, the third peaking gain value is predetermined as a value approximating “1” which corresponds to the nearly non-amplified noise included in the input image signal.

Also, if it is judged that the amount of noise in the input image signal is within the first reference noise range or the second reference noise range, the operation control unit 235, with reference to the storage unit 220, provides the first or second peaking gain value, respectively, as an input of the peaking filter unit 250 to be described later.

In addition, the operation control unit 235 controls the filter unit 240 to pass a specified frequency band of the input image signal on the basis of the result of frequency comparison provided from the judgment unit 231.

Specifically, if the judgment unit 231 judges that the frequency of the input image signal is lower than the first reference frequency, the operation control unit 235 outputs the input image signal to the low pass filter (LPF) 241. If the judgment unit 231 judges that the frequency of the input image signal is higher than the first reference frequency but is lower than the second reference frequency, the operation control unit 233 outputs the image signal to the band pass filter (BPF) 243. If the judgment unit 231 judges that the frequency of the image signal is higher than the second reference frequency, the operation control unit 233 outputs the image signal to the high pass filter (HPF) 245.

The filter unit 240 passes only a signal of a specified frequency band of the input image signal under the control of the operation control unit 233. The filter unit 240 comprises the low pass filter 241, the band pass filter 243, and the high pass filter 245.

The low pass filter 241 performs a frequency filtering in a manner that it passes the frequency component of the input image signal that is lower than the first reference frequency and removes the frequency component of the input image signal that is higher than the first reference frequency, and then outputs the filtered image signal.

The band pass filter 243 performs a frequency filtering in a manner that it passes the frequency component that is higher than the first reference frequency but is lower than the second reference frequency and removes the frequency component that is higher than the second reference frequency, and then outputs the filtered image signal.

The high pass filter 245 performs a frequency filtering in a manner that it passes the frequency component that is higher than the second reference frequency and removes the frequency component that is lower than the second reference frequency, and then outputs the filtered image signal.

The H/V peaking filter unit 250, on the basis of the result of judgment provided from the judgment unit 231, amplifies the input image signal by multiplying the image signal input from the control unit 230 or from the filter unit 240 by any one of the first to third peaking gain value, and outputs the amplified image signal.

Specifically, if the judgment unit 231 judges that the amount of noise in the input image signal is within the third reference noise range, the peaking filter unit 250, under the control of the operation control unit 233, multiplies the input image signal by the input third peaking gain value, and outputs the multiplied signal. If the judgment unit 231 judges that the amount of noise in the input image signal is within the first reference noise range, the peaking filter unit 250, under the control of the operation control unit 233, multiplies the input image signal by the input first peaking gain value, and outputs the multiplied signal. If the judgment unit 231 judges that the amount of noise in the input image signal is within the second reference noise range, the peaking filter unit 250, under the control of the operation control unit 233, multiplies the input image signal by the input second peaking gain value, and outputs the multiplied signal.

The signal processing unit 270 removes the noise from the image signal input from the peaking filter unit 250, performs a detail improvement of the image signal, and then generates viewable image data. Then, the signal processing unit 270 provides the generated image data to the output unit 280.

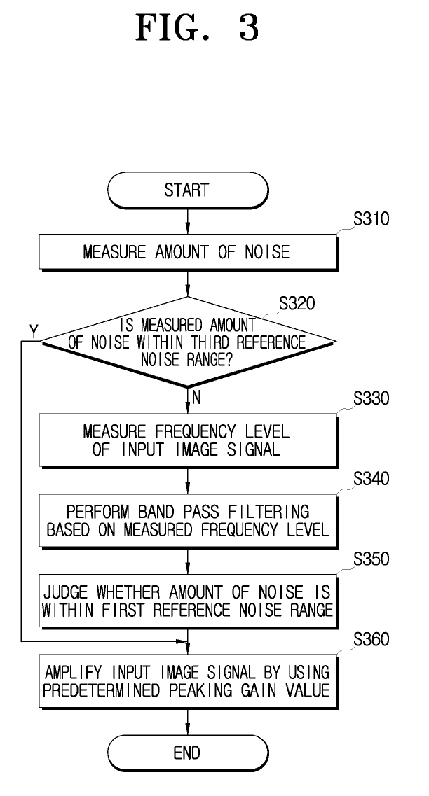

FIG. 3 is a flowchart illustrating a method of operating the image reproducing apparatus according to an exemplary embodiment of the present invention.

Referring to FIG. 3, the noise measuring unit 210 first measures the amount of noise included in the input image signal (S310).

Specifically, the noise measuring unit 210 performs a sampling of frequencies existing in a blank period of a vertical sync signal of the input image signal, and obtains an average of the sampled frequencies to measure the amount of noise.

Then, the judgment unit 231 judges whether the measured amount of noise is within a predetermined third reference noise range (S320).

If it is judged that the measured amount of noise is not within the third reference noise range (“N” (S320)), the frequency level measuring unit 233 measures the frequency level of the input image signal (S330).

Specifically, if it is judged that the measured amount of noise is not within the third reference noise range, but is within the first or second reference noise range (S320), the frequency level measuring unit 233 measures the frequency level of the input image signal by obtaining an average of the levels of the frequencies included in the input image signal, and outputs the measured frequency level of the input image signal.

Then, the judgment unit 231 compares the measured frequency level with the predetermined first and second reference frequencies, and controls the filtering to pass a specified frequency band of the input image signal on the basis of the result of frequency comparison (S340).

Specifically, if the judgment unit 231 judges that the frequency level of the input image signal measured (S330) is lower than the first reference frequency, the operation control unit 233 outputs the input image signal to the low pass filter 241, and the low pass filter 241 passes the frequency that is lower than the first reference frequency among the frequencies of the image signal.

If the frequency of the input image signal is higher than the first reference frequency but is lower than the second reference frequency, the operation control unit 233 outputs the input image signal to the band pass filter 243, and the band pass filter 243 passes the frequency that is higher than the first reference frequency but is lower than the second reference frequency.

If it is judged that the frequency level of the input image signal is higher than the second reference frequency, the operation control unit 233 outputs the input image signal to the high pass filter 245, and the high pass filter 245 passes the frequency that is higher than the second reference frequency among the frequencies of the input image signal.

Meanwhile, the judgment unit 231 judges whether the amount of noise in the input image signal is within the first reference noise range (S350), and the peaking filter unit 250 amplifies the input image signal by multiplying the input image signal, of which the specified frequency band has been filtered, by the predetermined peaking gain value, and outputs the amplified input image signal (S360).

Specifically, if the judgment unit 231 judges that the amount of noise measured (S310) is within the range of the predetermined first reference noise, the peaking filter unit 250 multiplies the input image signal filtered (S340) by the predetermined first peaking gain value to output the multiplied signal. By contrast, if the judgment unit 231 judges that the amount of noise measured (S310) is within the range of the predetermined second reference noise, the peaking filter unit 250 multiplies the input image signal filtered (S340) by the predetermined second peaking gain value to output the multiplied signal.

On the other hand, if it is judged that the measured amount of noise is within the predetermined third reference noise range (“Y” (S320)), the peaking filter unit 250 multiplies the input image signal by the predetermined third peaking gain value to output the multiplied signal.

In the exemplary embodiment of the present invention, the specified frequency band of the input image signal passes using a plurality of filters. However, the present invention is not limited thereto, and it is also possible to filter the frequency band of the input image signal using one filter that supports frequency variation.

In addition, in the exemplary embodiment of the present invention, if the input image signal is a broadcast signal, a tuner is provided along with the noise measuring unit 210, while if the input image signal is received through a lens, a lens and an image pickup unit such as CCD, CMOS, and so forth, are provided along with the noise measuring unit 210.

As described above, according to an aspect of the present invention, since the amount of noise included in the input image signal and the frequency level of the input image signal are measured and the input image signal is selectively filtered based on the measured noise and frequency level, the noise included in the input image signal can be reduced with the image quality improved.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An image reproducing apparatus comprising:
a first filter unit which filters an input image signal;
a second filter unit which amplifies the input image signal filtered through the first filter unit; and
a control unit which measures a frequency level of the input image signal and controls the first filter unit to filter the input image signal based on the measured frequency level of the input image signal.

2. The image reproducing apparatus of claim 1, further comprising a noise measuring unit which measures an amount of noise in the input image signal;
wherein the control unit controls the first filter unit to filter the input image signal based on the measured frequency level of the input image signal if the amount of noise in the input image signal is within a predetermined range.

3. The image reproducing apparatus of claim 1, wherein the first filter unit comprises a low pass filter;
wherein the control unit outputs the input image signal to the low pass filter if the measured frequency level of the input image signal is lower than a first reference frequency.

4. The image reproducing apparatus of claim 3, wherein the low pass filter passes a first frequency component that is lower than the first reference frequency.

5. The image reproducing apparatus of claim 3, wherein the first filter unit further comprises a band pass filter;
wherein the control unit outputs the input image signal to the band pass filter if the measured frequency level of the input image signal is lower than a second reference frequency

6. The image reproducing apparatus of claim 5, wherein the band pass filter passes a second frequency component that is higher than the first reference frequency but is lower than the second reference frequency.

7. The image reproducing apparatus of claim 5, wherein the first filter unit further comprises a high pass filter;
wherein the control unit outputs the input image signal to the high pass filter if the measured frequency level of the input image signal is higher than the second reference frequency.

8. The image reproducing apparatus of claim 7, wherein the high pass filter passes a third frequency component that is higher than the second reference frequency.

9. The image reproducing apparatus of claim 1, wherein the control unit outputs the input image signal to the second filter unit if the amount of noise in the input image signal is within a predetermined range.

10. The image reproducing apparatus of claim 1, further comprising a noise measuring unit which measures an amount of noise in the input image signal;
wherein the control unit provides a predetermined peaking gain value to the second filter unit if the amount of noise in the input image signal is within a predetermined reference noise range.

11. The image reproducing apparatus of claim 10, wherein the control unit provides a predetermined first peaking gain value to the second filter unit if it is judged that the amount of noise in the input image signal is within a predetermined first reference noise range, provides a predetermined second peaking gain value to the second filter unit if it is judged that the amount of noise in the input image signal is within a predetermined second reference noise range, and provides a predetermined third peaking gain value to the second filter unit if it is judged that the amount of noise in the input image signal is within a predetermined third reference noise range; and
wherein the second filter unit amplifies the input image signal by multiplying the input image signal by any one of the first peaking gain value, the second peaking gain value, and the to third peaking gain value

12. A method of improving an image quality, comprising:
measuring a frequency level of the input image signal;
filtering an input image signal based on the measured frequency level of the input image signal; and
amplifying the filtered input image signal.

13. The method of claim 12, further comprising measuring an amount of noise included in the input image signal
wherein the filtering the input image signal based on the measured frequency level of the input image signal comprises determining if the amount of noise in the input image signal is within a predetermined range.

14. The method of claim 12, wherein the filtering the input image signal comprises:
low pass filtering if the measured frequency level of the input image signal is lower than a first reference frequency.

15. The method of claim 14, wherein the low pass filtering comprises passing a first frequency component that is lower than the first reference frequency, among frequencies of the input image signal;

16. The method of claim 14, wherein the filtering the input image signal further comprises:
band pass filtering if the measured frequency level of the input image signal is lower than a second reference frequency.

17. The method of claim 16, wherein the band pass filtering comprises passing a second frequency component that is higher than the first reference frequency but is lower than the second reference frequency, among the frequencies of the input image signal.

18. The method of claim 12, wherein the filtering the input image signal further comprises:
high pass filtering if the measured frequency level of the input image signal is higher than the second reference frequency.

19. The method of claim 18, wherein the high pass filtering comprises passing a third frequency component that is higher than the second reference frequency, among the frequencies of the input image signal.

20. The method of claim 12, further comprising filtering the image signal if an amount of noise in the input image signal is within a predetermined range.

21. The method of claim 12, further comprising measuring an amount of noise included in the input image signal;
amplifying the input image signal based on a predetermined peaking gain value if the amount of noise in the input image signal is within a predetermined reference noise range

22. A controller for removing noise from an image signal, comprising:
a frequency measuring unit which measures a frequency of the image signal based on an amount of noise in the image signal;
a comparison unit which compares the frequency of the image signal with a reference frequency, and generates a comparison result; and
an operational control unit which controls a filtering of the noise from the image signal based on the generated comparison result.
